(19) United States
(12) Patent Application Publication
(10) Pub. No.: US 2006/0126745 A1
(43) Pub. Date: Jun. 15, 2006

(54) System and method for increasing signal strength at a receiver in transmission lines with high attenuation

(76) Inventors: Ejaz Ul Haq, Sunnyvale, CA (US); James R. Slager, Saratoga, CA (US)

Correspondence Address: BROWN RAYSMAN MILLSTEIN FELDER & STEINER LLP, 303 TWIN DOLPHIN DRIVE, SUITE 600, REDWOOD SHORES, CA, 94065, US

(21) Appl. No.: 10/159,488

(22) Filed: May 31, 2002

Related U.S. Application Data
(60) Provisional application No. 60/295,347, filed on Jun. 1, 2001.

(51) Int. Cl. H04L 25/00

(52) U.S. Cl. 375/257

(57) ABSTRACT

A system and method increases signal strength at a receiver in transmission lines with high attenuation. The system comprises a transmitter for transmitting a pair of complementary oscillating voltage and timing references and a signal across transmission lines to a receiver. Since the references oscillate every bit time, the references do not suffer from the lone pulse problem but do suffer from attenuation. Since the signal may remain in a single state for several bit times, the signal may suffer from the lone pulse problem. The receiver maintains the references and the signal oscillating about a reference voltage, and compares the signal against the references. Based on the comparison, the receiver determines whether the current signal state has changed since the last signal state. Since the receiver compares one signal that suffers from the lone pulse problem against a reference that does not, signal strength is improved. Further, to improve signal strength, the transmitter can include a pulse driver to drive further the signal in a particular direction while the signal is transitioning.

### PRIORITY REFERENCE TO PRIOR APPLICATIONS

This application claims benefit of and incorporates by reference provisional patent application Ser. No. 60/295,347, entitled “SYSTEM AND METHOD FOR INCREASING SIGNAL STRENGTH AT A RECEIVER IN TRANSMISSION LINES WITH HIGH ATTENUATION,” filed on Jun. 1, 2001, by inventors Ejaz U L Haq and James R. Slager.

### BACKGROUND

1. Field of the Invention

The field of the present invention pertains to data communications between digital systems. More particularly, the present invention relates to a method of increasing signal strength at a receiver in high-performance parallel data communication systems, which are subjected to high line attenuation between a transmitter and receiver.

2. Background Art

When a signal reaches steady state for several (e.g., about four) cycles, a subsequent pulse of opposite signal level is often of poor quality. Poor quality pulses lead to transmission of inaccurate data, address and/or control signals. This is referred to as the “lone pulse” or “first pulse” problem.

The lone pulse problem is caused by frequency roll-off or high-frequency attenuation characteristics of long transmission lines (including PCBs or cables), and exacerbated by the last signal level being driven to a maximum voltage level while the transmission line is being driven in a constant state. When a high frequency signal starts to run again, the driver cannot drive the signal from the maximum voltage level sufficiently in the other direction to achieve a quality signal. A constantly high-frequency signal on a transmission line typically does not experience the lone pulse problem, because the signal does not reach a maximum voltage level in either direction.

To address the lone pulse problem, current technologies involving high-speed and/or relatively long distance transmission lines (where this problem is prevalent) use differential signaling. FIG. 1 shows a simplified differential system 100. The source 105 transmits the differential signal 110a and /signal 110b (both signals being referred to as differential signal 110) over the transmission line 115 to a destination 125. The destination includes a receiver 120 and termination resistance RTerm 125. As the signal is transmitted, the transmission line 115 causes the transmitted signal 110 to attenuate by the time it reaches the receiver 120. FIG. 2 illustrates an example of 50% attenuation. The full differential signal 205, which includes “eye opening” 210, is transmitted over transmission line 115 to receiver 120. Because of attenuation, receiver 120 receives differential signal 215. As shown, attenuation effects both sides of the differential pair, eliminating the “eye opening” 210 at the receiver 120 at 50% line attenuation. Even at lower attenuation (e.g., 40% attenuation), the eye opening 210 is significantly reduced making it difficult to operate reliably. FIG. 3 illustrates the signal 215 at receiver 120 over several bit times. As shown, the signal 215 starts at maximum signal swing at point 305 and reaches a steady oscillating state within a few bit times, if the signal is changing every bit time (i.e., max signal rate). However, because of 50% attenuation, there is no signal to capture at point 310.

One solution to the first pulse problem includes encoding data transmissions so that there are never long time periods when the signal is constant. Thus, because signals are changing, the first pulse problem is prevented. However, this encoding solution has proven problematic in parallel data transmission systems.

Another solution to the first pulse problem designed for interfacing standards using parallel data transmission (such as SCSI) is called “output equalization” or “pre-emphasis.” The output level driven from the transmitter is varied depending on the data pattern. If the data is constant for a few bit times, the signal swing is reduced in the signal transmitter. U.S. Pat. No. 6,222,388 (the '388 patent) describes an example of output equalization. As shown in FIG. 7 of the '388 patent, the system may use activity detection circuitry to detect when a signal has remained in steady state for a several bus cycles and enables an additional power boosting differential driver to deliver an appropriate amount of power for a limited time to produce a quality first pulse. The extra power needed to remedy the quality of the lone pulse is supplied only for the duration of the first pulse, so that output driver strength is minimized and total power that an integrated circuit dissipated over time is reduced. As shown in FIG. 5 of the '388 patent, the system may use step down control circuitry to reduce output drive strength in the output driver while an output remains in a particular state, thereby ameliorating the lone pulse problem. The step down control circuitry determines, after a specified number of clock pulses, how much power should be stepped down and in how many increments. When the output finally switches states, it switches at normal strength; the net effect is increased drive strength from the steady state to the new state.

However, since the '388 patent applies to differential signaling, the step down control circuitry must reduce output drive strength of both the signal and its complement to allow the differential swing to be reduced at the driver and the receiver when the signal is switching at a lower frequency. Similarly, the activity detection circuitry must enable additional power boosting to both the signal and its complement to force greater transition of both signals.

Therefore, a method and system are desired that would remedy this lone pulse problem without increasing complexity, power and cost.

### SUMMARY

This systems and methods of the present invention build upon the signaling techniques described in U.S. Pat. Nos. 6,160,423 and 6,151,648. As described, the systems and methods use a pair of complementary small-swing voltage and timing references (VTR's) to compare with multiple single-ended signals. Based on the comparisons, it can be determined whether the signal has changed or not changed state. The VTR's transition every bit time and reach a steady oscillating state in a few (e.g., about 4) bit times. Therefore, during normal operation of unidirectional point-to-point signaling, the VTR's act like a fixed oscillating signal, which is attenuated at the receiver. Therefore, the lone pulse problem does not affect the VTR signals, and affects only the signal which changes state randomly.

All the signals including the VTR pairs terminate at the receiver end to a voltage terminal, which is maintained approximately equal to the mid-point of the voltage swing. In one embodiment, output equalization or pre-emphasis of the single-ended signal is accomplished by pulsing part of the output driver for every data transition. If the data does not transition in the next bit time, no pulsing is provided. The output driver strength is thereby reduced, and the “mid-point termination” reduces the swing on the transmission line. The pull-up pulse and a pull-down pulse may be provided unconditionally on every data transition. The size of the pulse may be programmable based on the line attenuation. Attenuation is dependent on data rate, transmission distance and material of the transmission line. The duration of the pulse may be programmable depending on the data rate and is preferably around a single bit time.

### BRIEF DESCRIPTION OF THE DRAWINGS

FIG. 1 illustrates prior art simplified differential signaling;

FIG. 2 illustrates a prior art lone pulse case reaching 50% attenuation;

FIG. 3 illustrates a prior art waveform with 50% attenuation at the receiver with the signal starting from a steady state with no signal changes to changing every bit time and reaching an steady oscillating voltage;

FIG. 4 illustrates a signaling scheme using VTRs with mid-point termination;

FIG. 5 illustrates a signaling scheme for single-ended signals with mid-point termination;

FIG. 6(a) illustrates waveforms for a signal and VTR at 50% line attenuation;

FIG. 6(b) is a table illustrating signal attenuation at the receiver for the full differential and the “Jazio” cases;

FIG. 7 illustrates a multi-drop system, in accordance with an embodiment of the present invention;

FIG. 8 illustrates an example timing diagram for 2 VTR Read Data with 4-Bit Burst for the system of FIG. 7;

FIG. 9 illustrates an output equalization circuitry, in accordance with an embodiment of the present invention;

FIG. 10 illustrates output driver control, in accordance with FIG. 9;

FIG. 11 illustrates waveforms for signal and VTR at 50% line attenuation with output equalization in lone pulse case, in accordance with FIG. 9; and

FIG. 12 illustrates waveforms for signal and VTR at 50% line attenuation with output equalization with signal changing at the maximum rate, in accordance with FIG. 9.

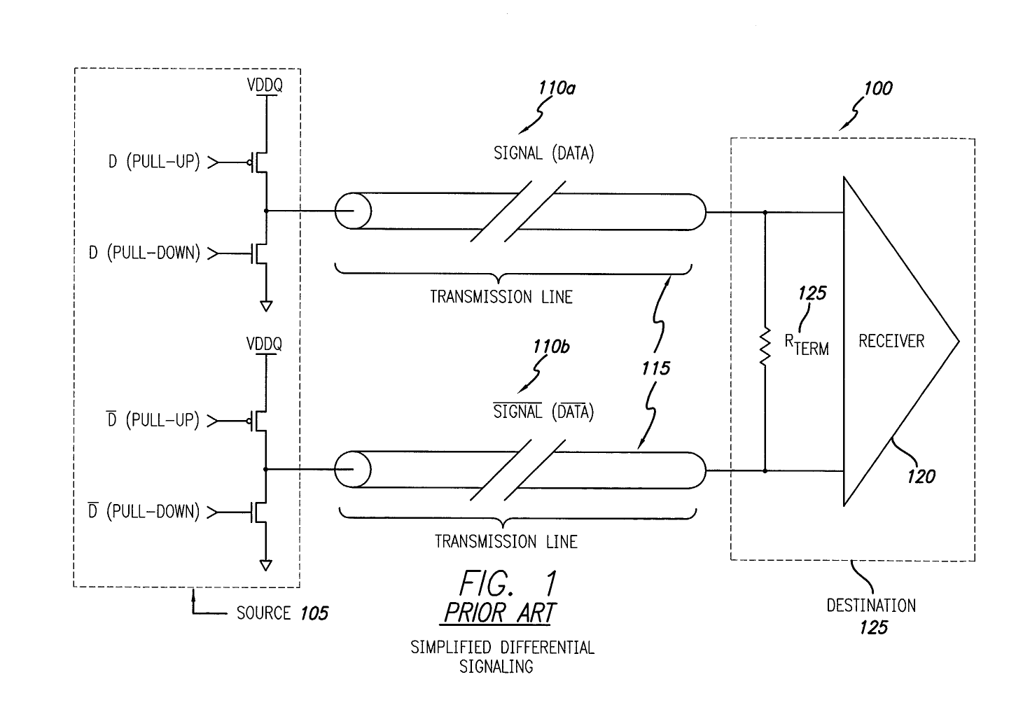

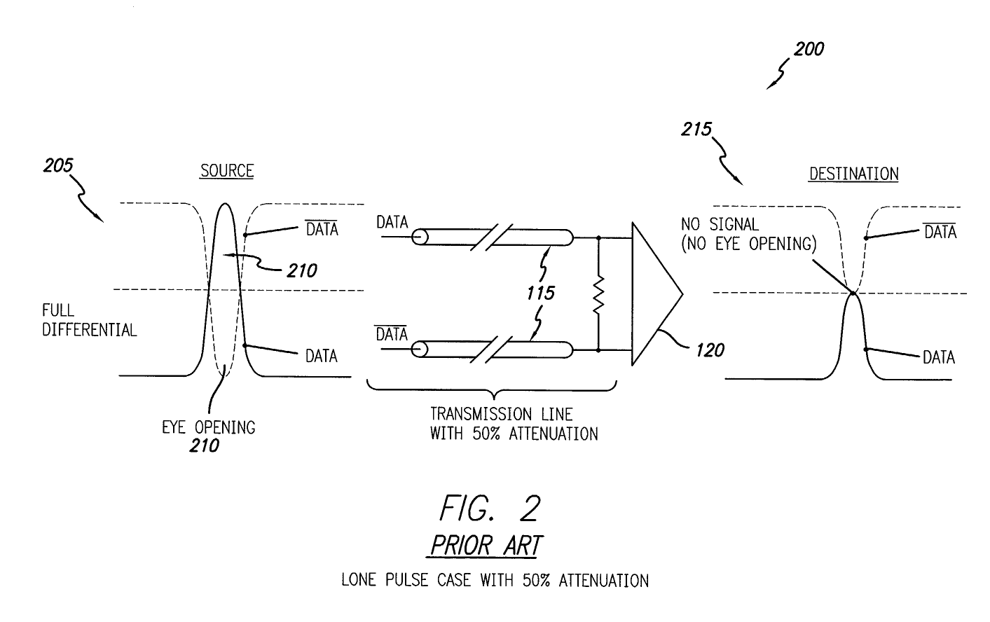

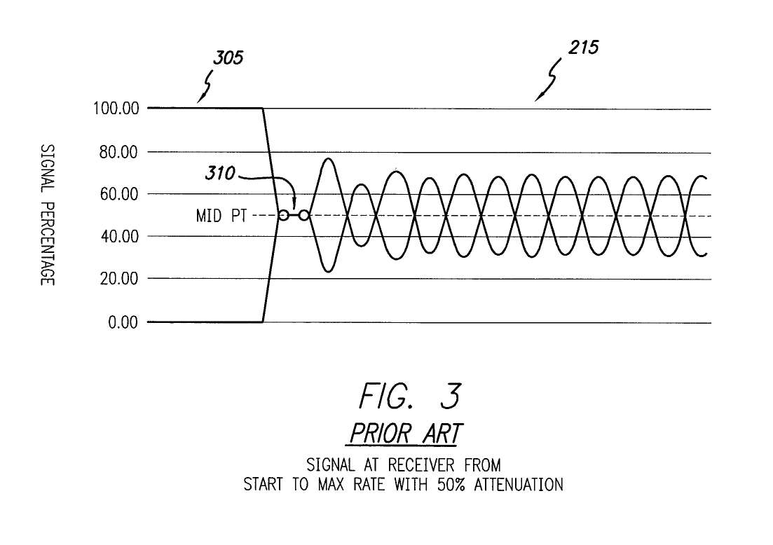

### DETAILED DESCRIPTION

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

This systems and methods of the present invention build upon the signaling techniques described in U.S. Pat. Nos. 6,160,423 and 6,151,648. The systems and methods use a pair of complementary small-swing voltage and timing references (VTR's) to compare with multiple single-ended signals. Based on the comparisons, it can be determined whether the signal has changed or not changed state. The VTR's transition every bit time and reach a steady oscillating state in a few (e.g., about 4) bit times. Therefore, during normal operation of unidirectional point-to-point signaling, the VTR's act like a fixed oscillating signal, which is attenuated at the receiver. Therefore, the lone pulse problem does not affect the VTR's, and affects only the signal which changes state randomly.

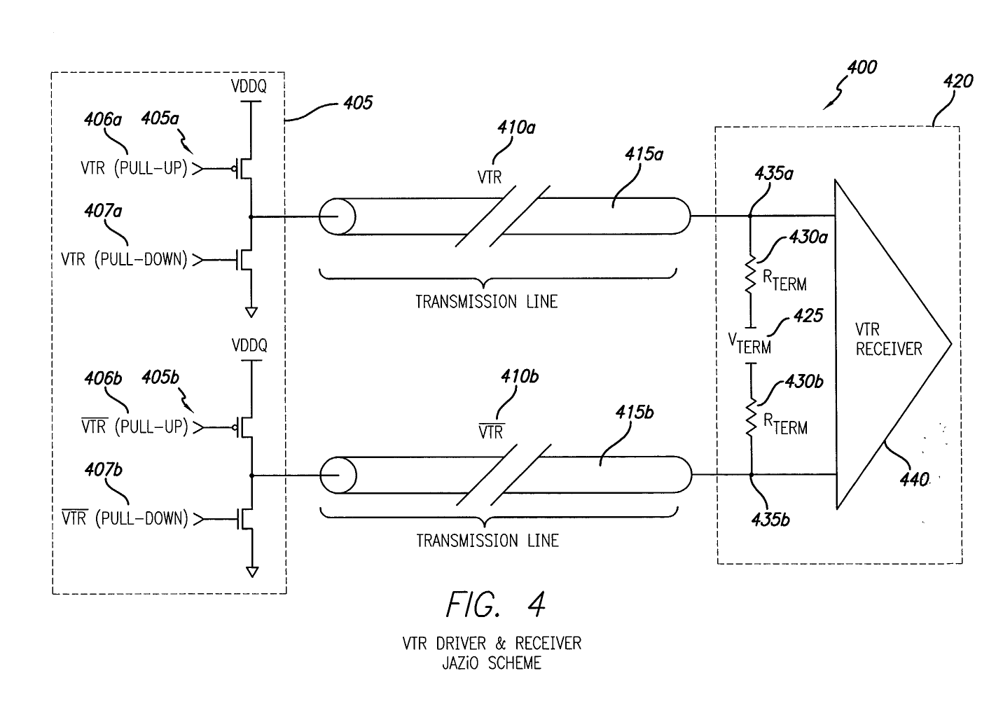

FIG. 4 illustrates a VTR driver and receiver system 400, in accordance with an embodiment of the present invention. System 400 includes VTR drivers 405, which include a VTR driver 405a for driving VTR 410a and a /VTR driver 405b for driving /VTR 410b. VTR driver 405a and /VTR driver 405b are similar, each including a pull-up device 406a/406b to drive the desired high-voltage level and a pull-down device 407a/407b to drive the desired low-voltage level. Driver 405a is coupled via a transmission line 415a to a destination 420, and driver 405b is coupled to a transmission line 415b also to destination 420. Destination 420 includes VTR receiver 440 and termination circuitry, and maintains oscillation of VTR and /VTR about a predetermined voltage VTerm at point 425. The termination circuitry includes a termination resistor RTerm 430a having a first end coupled to point 435a at the terminal end proximate the receiver 440 of the transmission line 415a. The termination circuitry further includes a second termination resistor RTerm 430b having a first end coupled to point 435b at the terminal end proximate the receiver 440 of the transmission line 415b. The second ends of resistor RTerm 430a and resistor RTerm 430b are coupled together at point 425. RTerm 430a and RTerm 430b are preferably the same resistance, so that VTerm is maintained at the mid-point of VTR and /VTR.

A gate driver is used to control the signal slew rate for compensating the variation in process; temperature and power supply are well known and understood for high-speed transmitters. The mid-point voltage reference VTerm is preferably around 0.8 v in the embodiment as shown in FIG. 4. The termination resistance and driver impedance is matched to the line impedance and is approximately 50 ohms. But, the termination voltages can be different depending on the desired power dissipation and material of the PCB, etc.

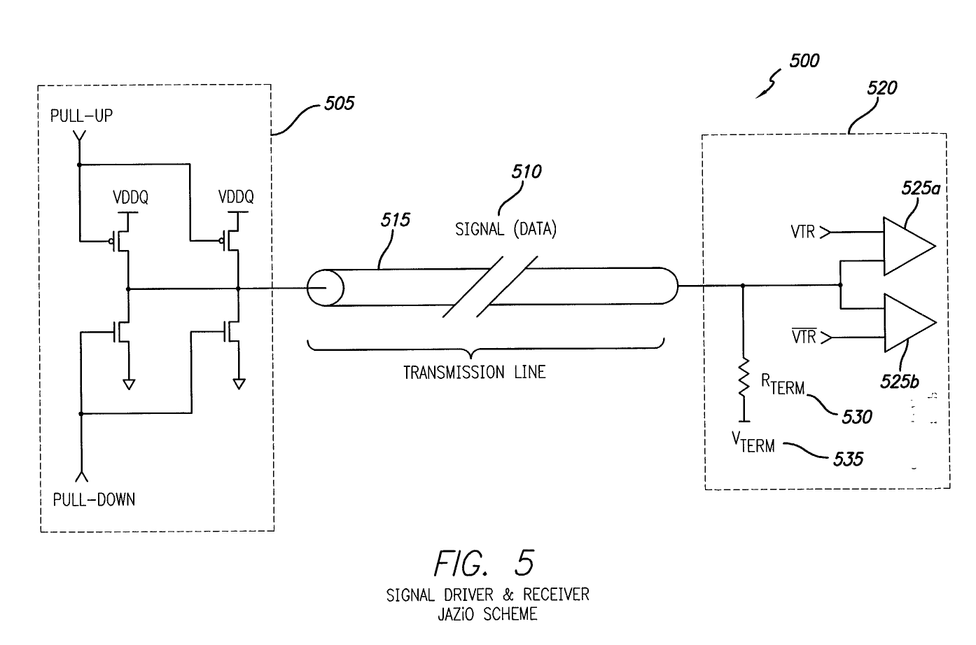

FIG. 5 shows a single-ended signal driver and receiver system 500, in accordance with an embodiment of the present invention. The system 500 includes a source 505 for driving a signal 510 via a transmission line 515 to a destination 520. Source 505 includes two signal drivers (each having a pull-up device and a pull-down device) coupled in series to provide additional power. The destination 520 has two comparators 525a and 525b for comparing the signal against the VTR's, as described in U.S. Pat. No. 6,160,423. Generally, comparator 525a compares the signal against VTR and comparator 525b compares the signal against /VTR. Rather than comparing the signal against a reference voltage to determine its state, the comparators 525a and 525b determine merely whether the signal has changed state. The destination 520 includes a termination resistance RTerm 530 coupled between the terminal end proximate the receiver 520 of the transmission line 515 and a termination voltage VTerm 535. It will be appreciated that the same VTR pair may be shared with multiple systems 500.

The signal swing is preferably symmetrical around VTerm 535, approximately 250 mv above and below VTerm 535 (e.g., 0.8 v). The VTR's preferably have a symmetrical swing above and below VTerm 425, and have amplitude dependent on attenuation. VTerm 535 (for the single-ended signals) is preferably the same as VTerm 425 (for the VTR's). The signal, which has no change for few cycles, will have maximum differential, and will reach only about VTerm if the attenuation is 50%. Having termination at the mid-point allows the signal to go below the mid-point if the previous driver is turned off before the new driver is turned on. In other words, one of the pull-up or pull-down device is turned off early, and the termination reduces the swing before the pull-down or pull-up device is turned on, respectively. The final amplitude on the signal in a lone pulse case is dependent on how much of the driven signal is attenuated at the receiver 520. At the minimum, it will reach the mid-point for 50% attenuation. The maximum is 75% if the termination pulls down the signal to the mid-point before the driver turns on and signal swing is attenuated by 50%.

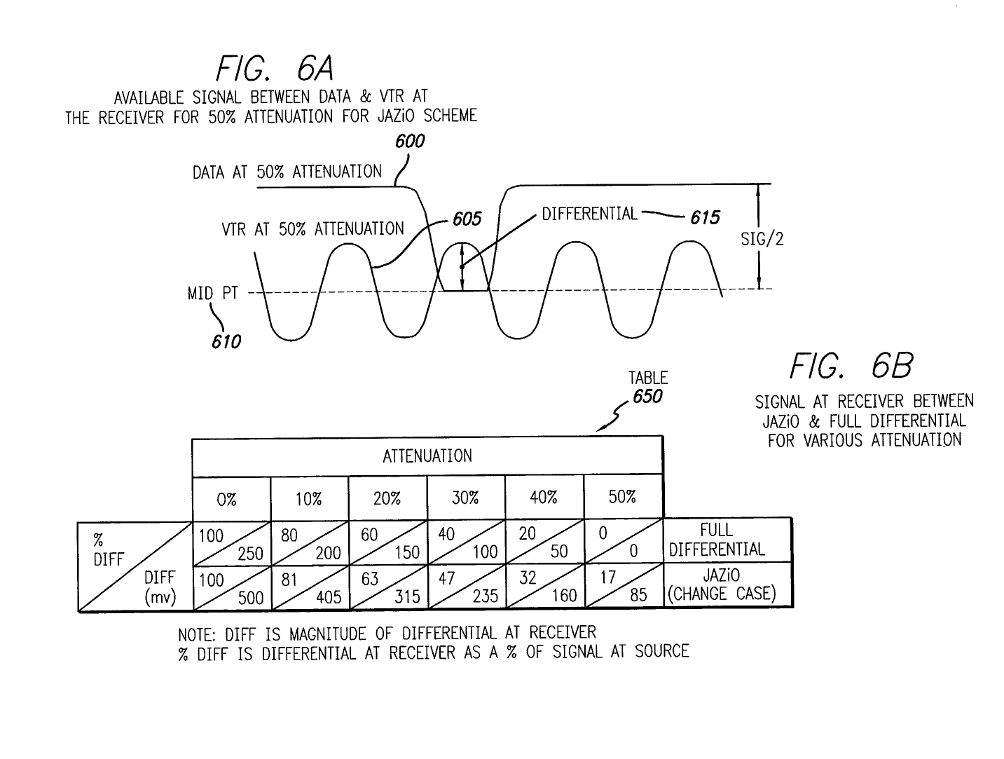

FIG. 6(a) shows the minimum signal available at the receiver for 50% attenuation. As shown, data signal 600 has 50% attenuation. VTR signal 605, having reached a steady state, also has 50% attenuation. Because both signals oscillate around mid-point voltage 610 and because only the signal 600 is affected by the lone pulse problem, differential 615 is available to detect a change in the signal. FIG. 6(b) is a table 650 comparing the signal available at a receiver for full differential and for Jazio-type signaling for various line attenuations. As shown, at all levels of attenuation, the Jazio-type signaling provides better differential values.

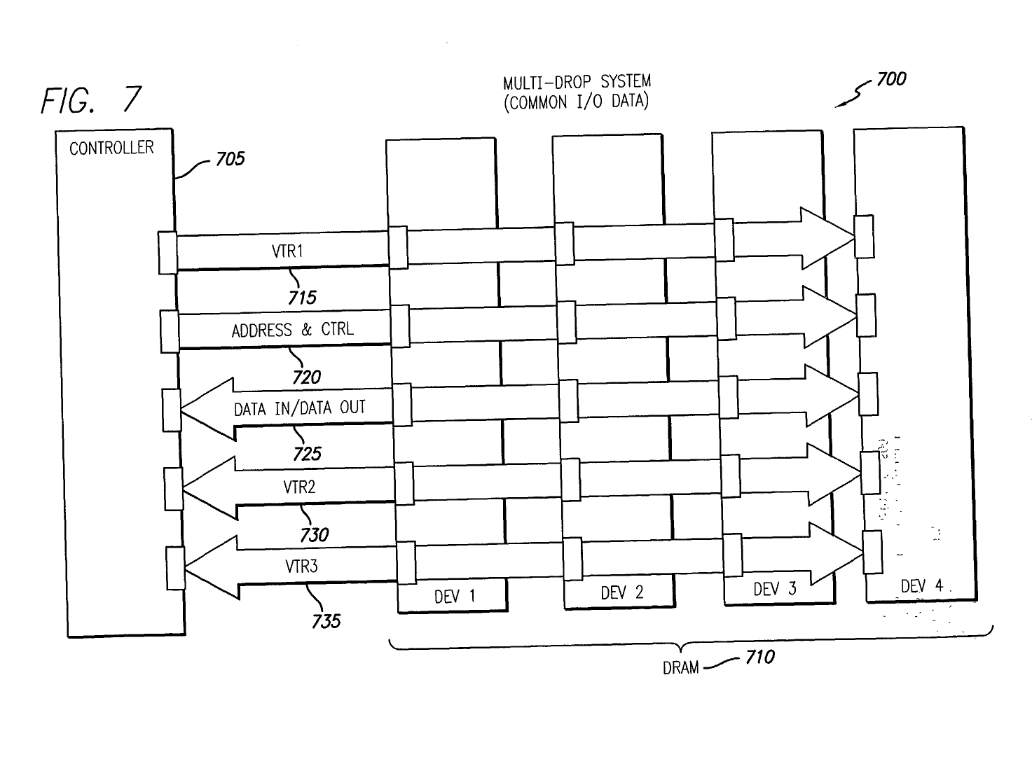

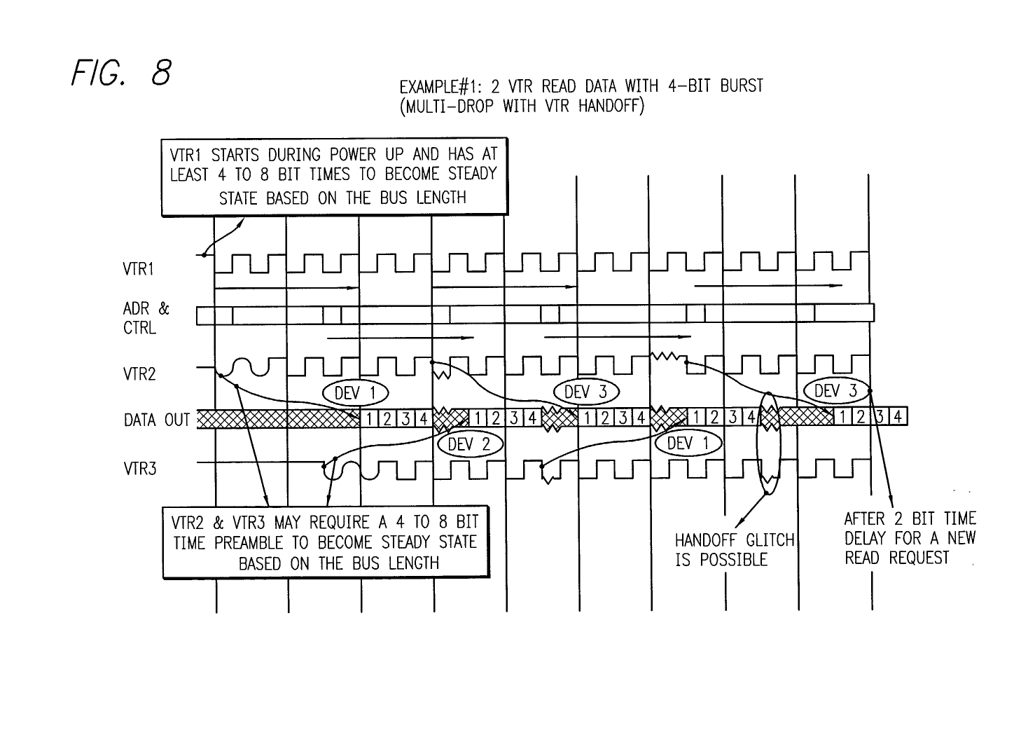

In multi-drop systems involving bidirectional signaling, performance variability of one or more first VTR's can be used to achieve steady oscillating state level in a second one or more VTR's. That is, multiple VTR's can be used to achieve steady oscillating state level in the desired VTR's. FIG. 7 shows an example multi-drop system 700 for DRAM. System 700 includes a DRAM controller 705 coupled via transmission lines to DRAM 710, which in this example includes four DRAM devices (DEV 1, DEV 2, DEV 3 and DEV 4). VTR1 715 is used as uni-directional references for address and control signals 720. VTR2 730 and VTR3 735 are used as two pairs of bi-directional references for each receiver. The data-in/data-out signals 725 are also bi-directional FIG. 8 shows an example timing diagram for the system 700 of FIG. 7. As shown in FIG. 8, VTR1 715 starts during power up and takes for example four (4) to eight (8) bit times based on the bus length to reach a steady oscillating state. VTR2 730 is set up eight (8) bit times ahead of data being sent from DEV 1. Therefore, VTR2 730 will achieve steady oscillating state at the receiver before data is received. The next read transaction occurs with VTR3 735 being set up by the same eight (8) bit times ahead of the data from DEV 2. In this example, each receiver has two “receivers” (each for example similar to destination 520 of FIG. 5) and a multiplexer select (not shown) which identifies one of the two receivers as the enabled one. Operation of a multiplexer select and multiple receivers is described in copending U.S. application Ser. No. 10/086,594, entitled “Method and System for Deskewing Parallel Bus Channels to Increase Data Transfer Rates,” filed on Feb. 27, 2002, by Ejaz Haq, et al., which is hereby incorporated by reference. By having two VTR pairs, namely, VTR2 730 and VTR3 735, and using hand-off techniques from one VTR to the other, a steady oscillating state can be achieved for read to read, read to write, write to read, and write to write (although unnecessary).

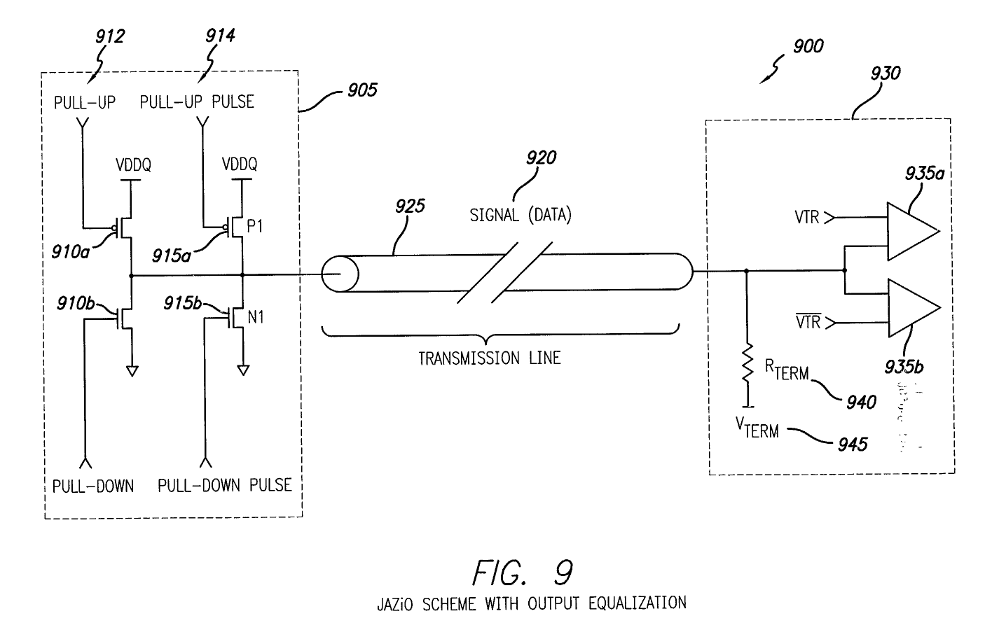

FIG. 9 describes a signal driver and receiver system 900, in accordance with an embodiment of the invention. A source 905 drives signal 920 via transmission line 925 to a destination 930. Source 905 includes an output driver 912 and an output pulse driver 914. Output driver 912 includes pull-up device 910a and pull-down device 910b. Output pulse driver 914 includes pull-up pulse device 915a and pull-down pulse device 910b. Both drivers 912 and 914 are turned on to deliver the normal drive strength for approximately one bit time for every signal transition. If in the next bit time there is no signal transition, the appropriate pull-up pulse or pull-down pulse of output pulse driver 914 is turned off, allowing the output signal to reduce swing. The discharge path of the signal 920 is through the RTerm 940 at the receiver 930. The size of the pull-up pulse and of the pull-down pulse of output pulse driver 914 is programmable based on amount of line attenuation present in the system 900.

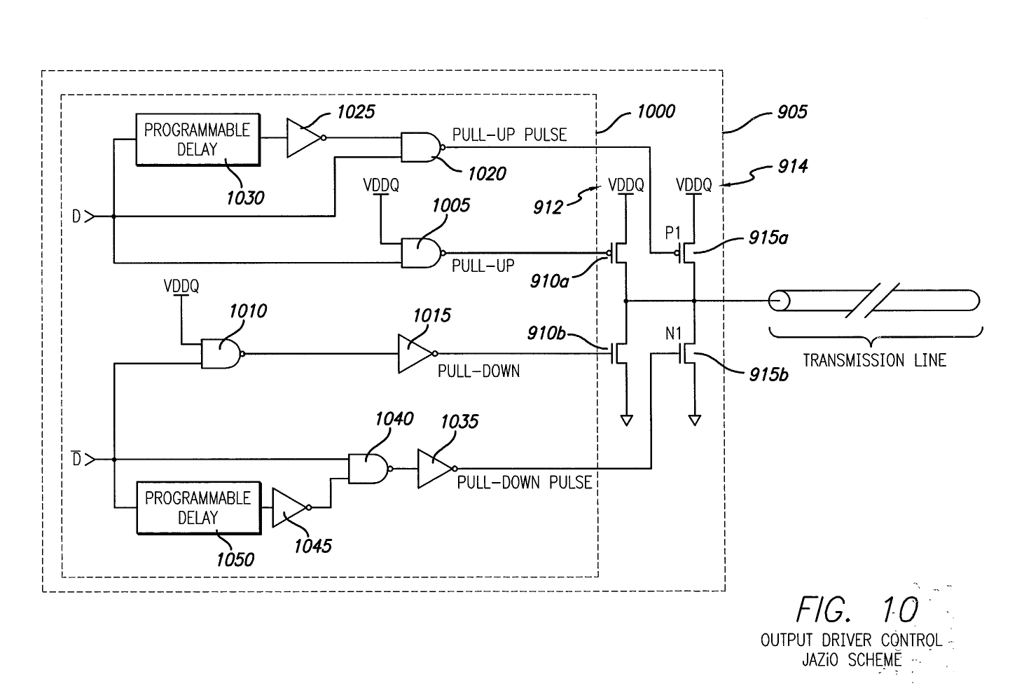

FIG. 10 shows details of an output pulse driver controller 1000 of source 905 for controlling output drivers 912 and 914. First logic circuitry drives the pull-up device 910a of output driver 912 active whenever data is high. In this embodiment, the first logic circuitry includes a nand gate 1005 receiving input from data signal D and Vddq. Second logic circuitry drives pull-down device 910b of output driver 912 active whenever the data signal is low. In this embodiment, the second logic circuitry includes an inverter 1015 receiving the output of a nand gate 1010 receiving inputs from the inverted data signal /D and Vddq. Third logic circuitry drives the pull-up device 915a of output pulse driver 914 for a single bit time whenever the data is transitioning from low to high. In this embodiment, the third logic circuitry includes a nand gate 1020 receiving input from the data signal D and from an inverter 1025 receiving the output of a programmable delay 1030 that preferably delays the data signal D a single bit time. Fourth logic circuitry drives the pull-down device 915b of output pulse driver 914 for a single bit time whenever the data is transitioning from low to high. In this embodiment, the fourth logic circuitry includes an inverter 1035 receiving input from a nand gate 1040. Nand gate 1040 receives input from the inverted data signal /D and from an inverter 1045 receiving input from a programmable delay 1050 that preferably delays the inverted data signal /D for a single bit time.

The programmable delays 1030 and 1050 preferably delay the signal approximately one bit time and are programmable to various bit times desired for the operation of the transceiver. Since the transceiver is intended for operation in the high signal attenuation range and the output is being equalized to an intermediate voltage, it is preferred to have larger swing on the signals compared to the VTR's. In one embodiment, the VTerm is set to 0.8 v with VTR swing of 0.5 v to 1.1 v (300 mv above and below VTerm) and the signal swing of 0.4 v to 1.2 v (400 mv above and below Term) at the transmitter, respectively. The VTR's settle to slightly higher than 200 mv swing (0.7 v to 0.9 v) at the receiver on the end of the line in a few bit times after their initial transition as they transition every bit time. The signals can start to operate after the VTR's settle. The voltage swing of the signals is 400 mv in the first bit time of signal transition (1.2 v for high level) at the transmitter, and if the signal does not transition then the pull-up pulse transistor of the appropriate size based on line attenuation (50% for this case) is turned off. The signal voltage level of 1.0 v is achieved at both the transmitter and the receiver very quickly as the effect of attenuation is reduced (attenuation increases approximately with the square root of the signal frequency). The 1.0 v level is chosen to be higher than the high level of VTR's at the receiver to allow noise margin for the no-change case, as described in U.S. Pat. Nos. 6,160,423 and 6,151,648. Similarly, the voltage swing of the first low-going transition is 400 mv below VTerm (0.4 v), and the equalized output low voltage is 0.6 v when the signal does not transition.

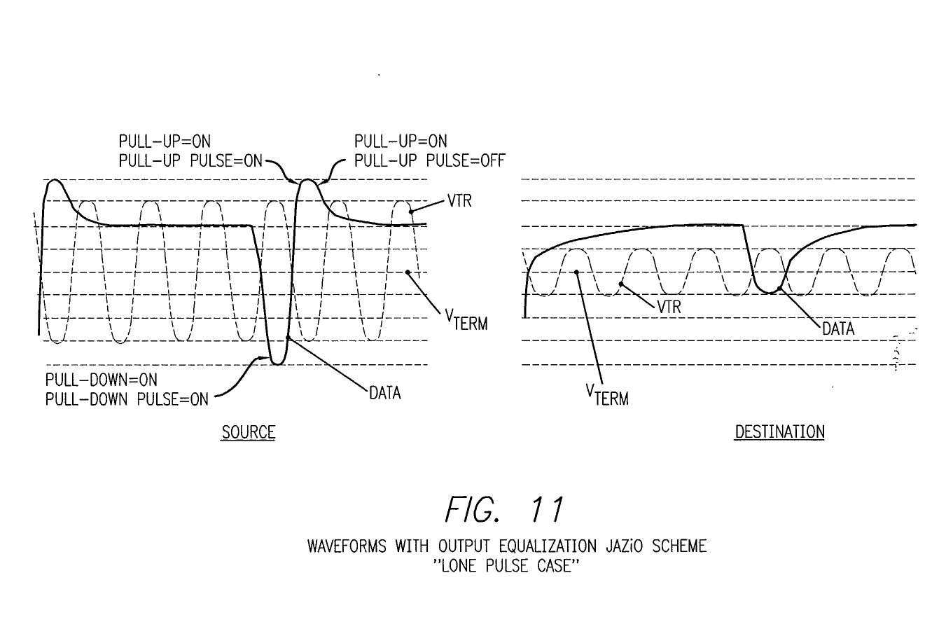

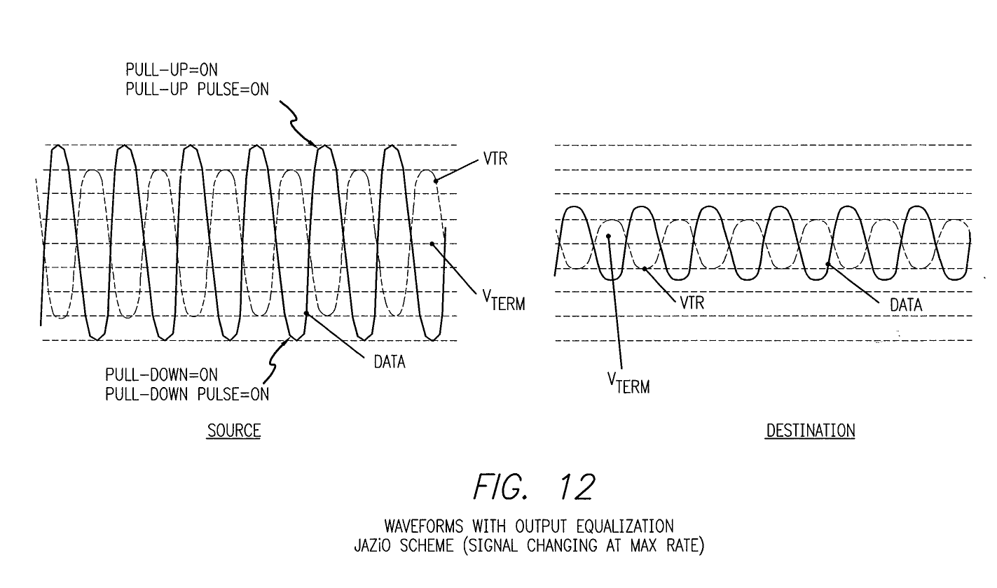

When the lone pulse occurs, the signal transitions from 1.0 v to 0.4 v at the transmitter and about half of it at the receiver from 1.0 v to 0.7 v. This is compared with VTR or /VTR high level, which is about 0.9 v to achieve a signal of 200 mv. This is shown in FIG. 11. The 200 mv signal at the receiver is sufficient for reliable operation at high speeds. In the low to high transition, the signal switches from 0.6 v to 1.2 v at the transmitter and about half of it at the receiver from 0.6 v to 0.9 v. This is compared to appropriate VTRs low level of 0.7 v achieving a signal of 200 mv. If the signal is transitioning every bit time, the output driver switches with normal drive strength every bit time and both pull-up pulse and pull-down pulse transistors are switched on or off with the other pull-up or pull-down devices, respectively, facilitating output equalization. The waveforms for this case are shown in FIG. 12. The swing of the signal is higher at both the transmitter and the receiver. In cases were the signal changes every other bit and so on, the signal at the receiver is somewhat higher than 200 mv, but less than the case when signal changes every bit time as shown in FIG. 12.

If the attenuation is lower than 50%, for example, if the VTRs swing is 600 mv (1.1 v to 0.5 v) at the transmitter and after line attenuation the swing at the receiver is 400 mv (1 v to 0.6 v), then the output equalization of the signal is adjusted to 1.1 v high level and 0.5 v low level for signals not changing every cycle. When the signal switches after staying at a steady level for few bit times for this attenuation, it will switch from 1.1 v or 0.5 v at the transmitter, instead of 1.2 v or 0.4 v, respectively, if the signal is changing every bit time. So, by having programmable device sizes for the pull-up pulse/pull-down pulse and by having programmable delay before the pulse is turned off, larger swing is obtained at the receiver for various attenuations. This technique can also be used with multiple VTRs offset in time. If the termination is different or open-drain-type output is used, this technique still applies; although the attenuation effects are asymmetrical, the output equalization still improves signal at the receiver for non-periodic signals.

The foregoing description of the preferred embodiments of the present invention is by way of example only, and other variations and modifications of the above-described embodiments and methods are possible in light of the foregoing teaching components of this invention may be implemented using a programmed general purpose digital computer, using application specific integrated circuits, or using a network of interconnected conventional components and circuits. Connections may be wired, wireless, modem, etc. The embodiments described herein are not intended to be exhaustive or limiting. The present invention is limited only by the following claims.

What is claimed is:

1. A receiver system, comprising:
circuitry for receiving complementary oscillating voltage and timing references from first transmission lines; and
circuitry for allowing the references to reach a steady oscillating state.

2. A method, comprising:
receiving complementary oscillating voltage and timing references from first transmission lines; and
allowing the references to reach a steady oscillating state.

3. A transmitter system, comprising:
first output driver circuitry for driving a first signal on a transmission line;
output pulse driver circuitry serially coupled to the output driver circuitry for applying a pulse on the transmission line every time and substantially only while the first signal is transitioning to drive further the first signal in a particular direction.

4. The system of claim 3, wherein the output pulse circuitry includes
second output driver circuitry coupled to the transmission line and in series with the first output driver circuitry;
a terminal for receiving a first input signal related to the first signal;
circuitry including delaying circuitry for generating a second input signal based on the first input signal; and
circuitry for comparing the first input signal and the second input signal, and generating based on the comparison an output signal to control the second output driver circuitry, the output signal indicating whether the first signal is transitioning.

5. The system of claim 4, wherein the delaying circuitry includes a programmable delay.

6. The system of claim 4, wherein the delaying circuitry delays the first input signal for about one bit time, and wherein the circuitry including the delaying circuitry inverts the delayed first input signal to generate the second input signal.

7. A method, comprising:
driving a first signal on a transmission line;
simultaneously applying a pulse on the transmission line every time and substantially only while the first signal is transitioning to drive further the first signal in a particular direction.

8. The method of claim 7, further comprising
receiving a first input signal;
at least delaying the first input signal to generate a second input signal based on the first input signal;
comparing the first input signal and the second input signal; and
generating based on the comparison an output signal to control the application of the pulse, the output signal indicating whether the first signal is transitioning.

9. An output pulse driver, comprising:
output driver circuitry for driving a first signal on a transmission line;
a first input signal;
circuitry including delaying circuitry coupled to the first input signal for generating a second input signal; and
circuitry for comparing the first input signal and the second input signal, and generating based on the comparison an output signal to control the output driver circuitry, the output signal indicating whether the first signal is transitioning.

10. The driver of claim 9, wherein the delaying circuitry includes a programmable delay.

11. The driver of claim 8, wherein the delaying circuitry delays the first input signal for about one bit time, and wherein the circuitry including the delaying circuitry inverts the delayed first input signal to generate the second input signal.

12. A method, comprising:
driving, by output driver circuitry, a first signal on a transmission line;
receiving a first input signal;
at least delaying the first input signal to generate a second input signal;
comparing the first input signal and the second input signal; and
generating based on the comparison an output signal to control the output driver circuitry, the output signal indicating whether the first signal is transitioning.
